(19) United States
(12) Patent Application Publication
(10) Pub. No.: US 2009/0001978 A1
(43) Pub. Date: Jan. 1, 2009

(54) Sensor system

(75) Inventors: Jialou Hu, Farmington Hills, MI (US); Scott Kerby, Wolverine Lake, MI (US); Len Cech, Farmington Hills, MI (US)

Correspondence Address: FOLEY AND LARDNER LLP;SUITE 500, 3000 K STREET NW, WASHINGTON, DC, 20007, US

(73) Assignee: TK HOLDINGS INC.

(21) Appl. No.: 12/213,299

(22) Filed: Jun. 17, 2008

Related U.S. Application Data
(60) Provisional application No. 60/929,190, filed on Jun. 18, 2007.
(60) Provisional application No. 60/929,689, filed on Jul. 9, 2007.

(51) Int. Cl. G01N 27/72

(52) U.S. Cl. 324/234

(57) ABSTRACT

A sensor system is provided. The sensor system includes an electrically conductive surface and an air coil in proximity to the electrically conductive surface. The air coil has a wire winding pattern with an “L” shaped cross section. The sensor system also includes a controller, coupled to the air coil and configured to sense a change in impedance of the air coil due to movement of the electrically conductive surface. A safety device is coupled to the controller. The controller activates the safety device if the change in impedance of the air coil exceeds a predetermined threshold.

### CROSS REFERENCE TO RELATED PATENT APPLICATIONS

This application claims benefit of and priority to U.S. Provisional Patent Application Nos. 60/929,190 and 60/929,689, incorporated by reference herein in their entirety.

### SUMMARY

The present disclosure relates generally to the field of air coil sensor systems. The disclosure more specifically relates to an air coil sensor system for actuating a safety device.

An air coil sensor system includes a square or rectangular-shaped cross-sectional winding pattern that may be used to generate an electromagnetic effect with an electrically conductive (e.g., metal) surface. Movement of the metal surface towards the coil or away from the coil causes a change in the electromagnetic effect resulting in a change in impedance and inductance of the surface and coil. A controller may be used to sense this change in impedance or inductance. In a vehicle, this sensed change (e.g., resulting from an accident causing the vehicle body to buckle, dent, or move) may prompt the actuation of a safety device such as an airbag. U.S. Patent Publication Nos. 20080068008, 20070024277, WIPO Publication No. WO2007114870, and U.S. Pat. Nos. 7,212,895, 7,209,844, and 6,587,048 describe various magnetic sensing systems and are incorporated by reference herein in their entirety. The coil and systems disclosed herein may be used in conjunction with the systems disclosed in the aforementioned patent publications.

Generally, adding winding turns to these rectangular or square shaped coil winding systems is a way to increase the intensity or sensitivity of the measurements. However, the total impedance level also increases with number of turns, and could be difficult to control. Thus the required driving power is high, resulting in additional cost.

Therefore, there is a need for an improved sensor system that results in a high sensitivity measurement without increasing the total impedance level. There is also a need for a lower cost sensor system capable of generating a higher sensitivity measurement. There is also a need for a low cost coil that results in a high sensitivity measurement without increasing the total impedance level.

According to one disclosed embodiment, a sensor system includes an electrically conductive surface, an air coil, in proximity to the electrically conductive surface, having a wire winding pattern with an “L” shaped cross section, a controller, coupled to the air coil, configured to sense a change in impedance of the air coil due to movement of the electrically conductive surface, and a safety device, coupled to the controller.

According to another embodiment, a sensor system includes an electrically conductive surface, an air coil, in proximity to the electrically conductive surface, having a wire winding pattern with an “U” shaped cross section, a controller, coupled to the air coil, configured to sense a change in impedance of the air coil due to relative movement between the coil and the electrically conductive 1 surface, and a safety device, coupled to the controller.

According to yet another embodiment, a sensor system includes an electrically conductive surface, an air coil, in proximity to the electrically conductive surface, having a wire winding pattern with an arch shaped cross section, a controller, coupled to the air coil, configured to sense a change in impedance of the air coil due to relative movement between the coil and the electrically conductive surface, and a safety device, coupled to the controller.

According to still another embodiment, an air coil includes a wire winding pattern, having an “L” shaped cross section.

It is to be understood that both the foregoing general description and the following detailed description are exemplary and explanatory only, and are not restrictive of the invention as claimed.

### BRIEF DESCRIPTION OF THE DRAWINGS

FIG. 1 is a block diagram illustrating a sensor system that includes a coil according to an exemplary embodiment.

FIG. 2 is a schematic diagram illustrating the magnetic interaction of the coil of FIG. 1 with an electrically conductive surface according to an exemplary embodiment.

FIG. 3 is a circuit diagram illustrating the electrical coupling between the coil and electrically conductive surface of FIG. 1 according to one exemplary embodiment.

FIG. 4 is a schematic diagram illustrating section views of coil configurations in the sensor system of FIG. 1 according to various exemplary embodiments.

FIG. 5 is a graph illustrating the change in impedance between the coil and electrically conductive surface of FIG. 1 for coil shapes according to various exemplary embodiments.

FIG. 6 is a schematic diagram illustrating section views and information of coil configurations in the sensor system of FIG. 1 according to various exemplary embodiments.

FIG. 7 includes a number of graphs illustrating the magnitude signal modulation of the coil and electrically conductive surface of FIG. 1 with the coil configurations of FIG. 6, according to various exemplary embodiments.

FIG. 8 is a photograph of the coil of FIG. 1 with an “L” shaped winding according to an exemplary embodiment.

FIG. 9 is a partial side view of a vehicle showing the door panel and adjoining beams.

### DETAILED DESCRIPTION

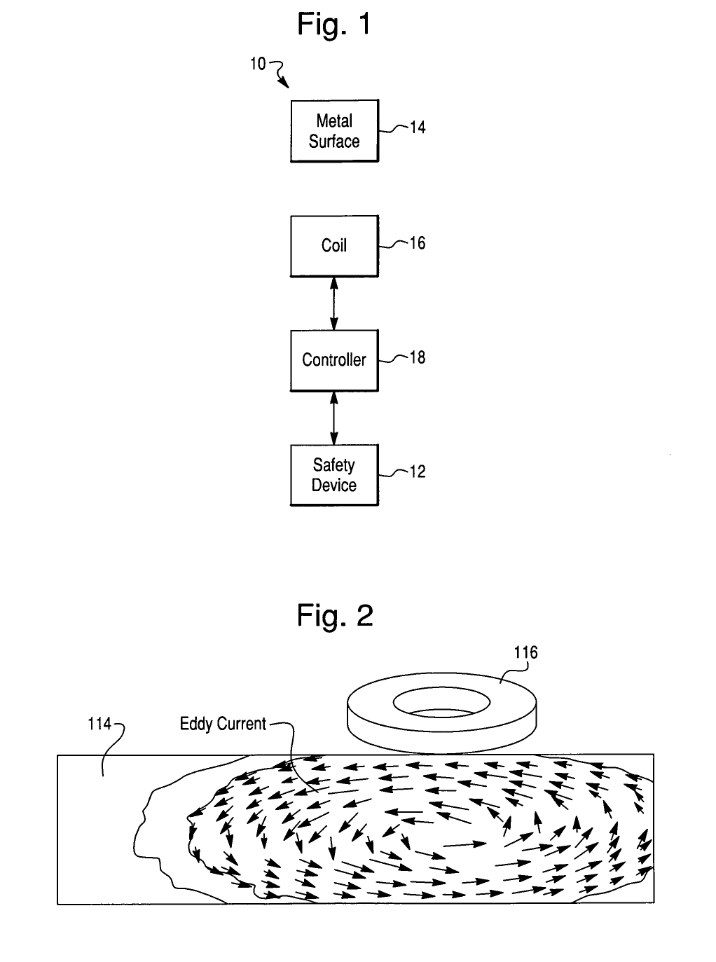

Referring to FIG. 1, a sensor system 10 is configured to actuate a safety device 12 based on a sensed impedance or inductance. The sensor system 10 further includes an electrically conductive (e.g., metal) surface 14, a coil 16, and a controller 18. Safety device 12 is configured to provide a safety feature, for example to a vehicle occupant. According to one exemplary embodiment, the safety device 12 may be a side-impact airbag. According to another exemplary embodiment, the safety device 12 may be a front or rear-impact airbag. According to still another exemplary embodiment, the safety device 12 may be a seatbelt. According to other exemplary embodiments, the safety device 12 may be any safety device capable of being implemented in a vehicle.

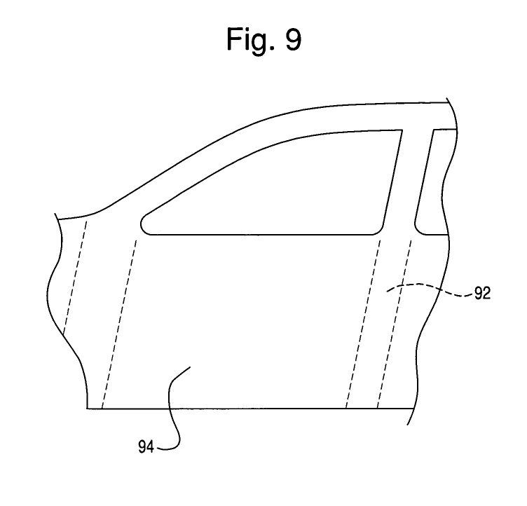

The electrically conductive surface 14 is typically composed of electrically conductive material such as aluminum, or a ferrous metal, but according to other exemplary embodiments, may be composed of any magnetic material. As shown in FIG. 9, according to one exemplary embodiment, the electrically conductive surface 14 may be a vehicle door panel 94. According to another exemplary embodiment, the electrically conductive surface 14 may be a metal plate attached to a vehicle door panel. As shown in FIG. 9, according to yet another exemplary embodiment, the electrically conductive surface 14 is a beam 92 or a target metal plate attached to the beam 92. According to other exemplary embodiments, the electrically conductive surface 14 may be any conductive material, metal plate or other magnetic surface.

The coil 16, for example an air coil, is generally a coil capable of sensing movement of the electrically conductive surface 14. Typically, the winding pattern of the coil 16 allows increased sensitivity without increases in impedance (yielding an increased drive current). The winding geometry of the coil 16 may provide a solution that meets vehicle packaging constraints while maintaining electrical characteristics used for impact sensing. The coil 16 is intended to have a reduced self inductance (the coil 16 in the air, or the coil 16 without the electrically conductive surface 14), maintain or increase the mutual-inductance to the electrically conductive surface 14, and maintain or reduce the impedance of the coil 16. The coil 16 with a smaller self-inductance and larger mutual-inductance to the surface plate 14 may yield a higher sensitivity to movement by the electrically conductive surface 14 (intrusion measurement), while the total impedance level of the sensor system 10 may be maintained or reduced. The winding pattern of the coil 16 may achieve lower self-inductance (without the electrically conductive surface 14 involved), while keeping the mutual-inductance of the sensor system 10 with the electrically conductive surface 14 as large as possible to create a high-sensitivity coil. In an exemplary embodiment where the coil 16 is used in a vehicle door, the coil 16 may be attached to an inner wall of the vehicle door. Alternatively, the coil 16 may attached to a beam within the vehicle door. The coil 16 may also be attached to or integrated with the controller 18.

The controller 18 is configured to provide electrical current to the coil 16, monitor changes in impedance or inductance due to the coil 16 interacting with the electrically conductive surface 14, and actuate the safety device 12 based on the changes with respect to a predefined threshold. According to various exemplary embodiments the controller 18 may be any hardware or software controller capable of managing current to the coil 16, monitoring changes in the coil 16 impedance, and actuating the safety device 12 based on the changes.

Referring to FIG. 2, the electromagnetic effect of an exemplary coil 116 with an exemplary electrically conductive surface 114 is illustrated. The electromagnetic effect includes an eddy current flow of electrons on and within the electrically conductive surface 114. If the electrically conductive surface 114 is moved closer to the coil 116 (increasing the strength of the electromagnetic effect), the density of the electrons in the eddy current will typically increase thus increasing the current developed in the electrically conductive surface 114 and the coil 116.

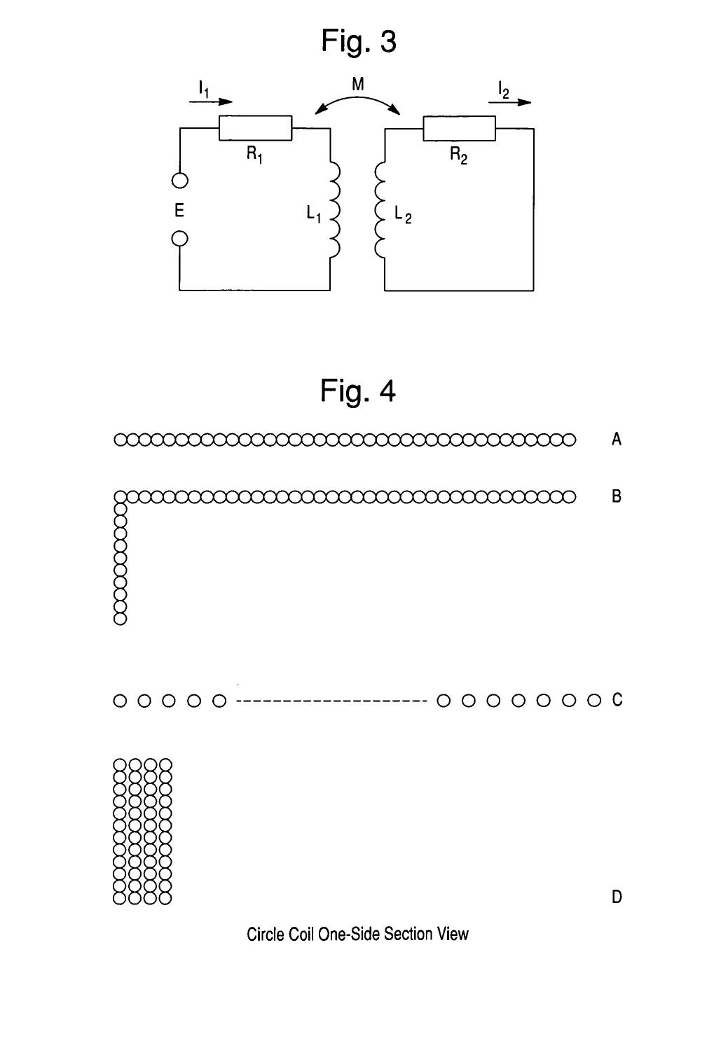

Referring to FIG. 3, an equivalent circuit of the electrically conductive surface 14 and interaction with the coil 16 is presented. The coil 16 is represented by one inductor and resistor set (L1, R1) coupled to a power source E, while the electrically conductive surface 14 is represented by another inductor and resistor set (L2, R2). The system's impedance can be calculated by:

$$Z = \{ {R}_{1} + {R}_{2} \frac{{ω}^{2} {M}^{2}}{{R}_{2}^{2} + {( ω {L}_{2} )}^{2}} \} + j \{ ω {L}_{1} - ω {L}_{2} \frac{{ω}^{2} {M}^{2}}{{R}_{2}^{2} + {( ω {L}_{2} )}^{2}} \} \qquad ( 1 )$$

The real and imaginary parts of equation (1) are

Z=R+jωL or Z=R+jX (2)

The sensitivity of the measurement can be approximated by ΔZ/Zₜ₌₀ in mathematical notation. Since the impedance and inductance of the coil 16 has a big influence in the sensor system 10 (MSI Application), the main contribution of the ΔZ/Zₜ₌₀ may come from ΔX/Xₜ₌₀.

The ΔX/Xₜ₌₀ can be analyzed as follows, where:

$$X = ω \{ {L}_{1} - {L}_{2} \frac{{ω}^{2} {M}^{2}}{{R}_{2}^{2} + {( ω {L}_{2} )}^{2}} \} \qquad ( 3 )$$

In equation (3), L₁, the inductance of the coil 16 in the air, has a constant value. L₂, the inductance of the door in air related to the eddy current pattern, can be considered as constant if the permeability has only a minimum change under the sensor system (MSI) weak field. The same is true for R₂ and ω, which also have constant values, so the equation (3) can be re-written as:

L=L₁−KM² (4)

K has a constant value in the equation and thus the sensitivity is:

$$Δ X / {X}_{t = 0} = Δ L / {L}_{t = 0} = \frac{- 2 KM \cdot Δ M}{{L}_{1} - {KM}_{t = 0}^{2}} \qquad ( 5 )$$

In equation (5), only M is a function of intrusion; all other values are constants. To achieve a higher ΔX/Xₜ₌₀ value, M must be increased and L₁ decreased; or, the M level should be substantially maintained while allowing a significant drop in the L₁ value.

Similar conclusions can also be obtained from analysis of the real part of equation (1): ΔR/Rₜ₌₀.

Therefore, any coil section pattern or any coil shape design that yields a smaller L₁ and a larger M addressed by equation (5), may provide a relatively higher sensitivity of the intrusion measurement. Further, the number of winding turns of the coil 16 may control the total initial impedance level in the application.

Referring to FIG. 4, various coil 16 patterns (patterns A, B and C) may allow for higher sensitivity than that of the traditional winding of pattern D under similar conditions of coil size and winding number. According to one exemplary embodiment, the coil 16 may include coil pattern A, a flat coil pattern. According to another exemplary embodiment, the coil 16 may include coil pattern B, an “L” shaped coil pattern. According to still another exemplary embodiment, the coil 16 may include coil pattern C. According to yet another exemplary embodiment, the coil 16 may include a coil pattern of a “U” shape. According to another exemplary embodiment, the coil 16 may include a coil pattern of an arch shape. According to other exemplary embodiments, the coil 16 may include any coil pattern that produces less impedance or less voltage to drive than the conventional coil pattern D under similar conditions of coil size and winding number.

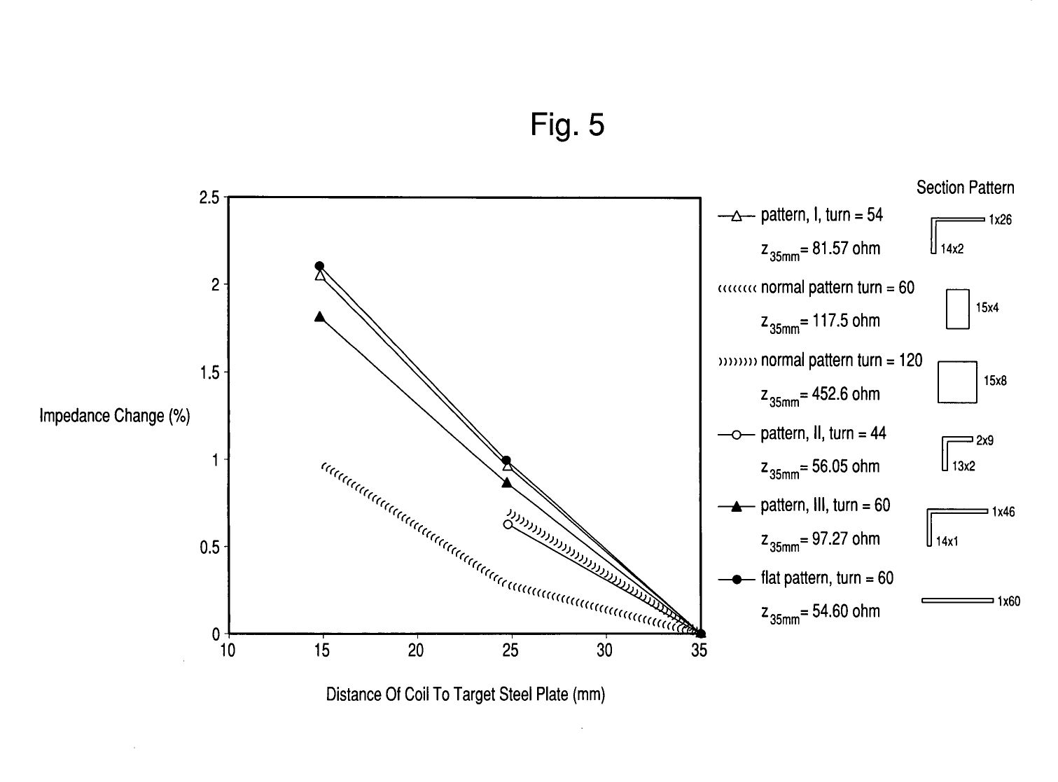

Referring to FIG. 5, a graph illustrates the impedance change between the coil 16 and electrically conductive surface 14 when the coil 16 has various exemplary coil winding patterns. As shown in FIG. 5, the initial distance between the electrically conductive surface 14 and the coil 16 is 35 mm. The conventional square and rectangular shaped windings produce a small impedance change when the electrically conductive surface 14 approaches the coil 16. The “L” shaped and straight coil 16 winding patterns, as well as any winding pattern with a reduced number of adjacent windings produce a larger impedance change and thus a greater signal when the electrically conductive surface 14 approaches the coil 16. This larger impedance change produces a more rapidly changing signal during an intrusion event upon the door and allows the controller 18 to generate fewer false signals to the safety device 12. Further, due to the magnitude of the signal generated by the coil 16 having the non-square shaped patterns, the controller 18 can actuate a safety device 12 in less time than with the square-shaped coils.

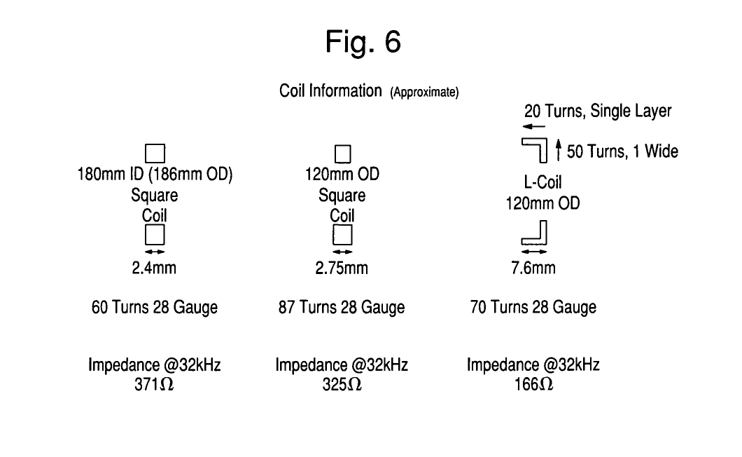

Referring to FIG. 6, cross-sections of two conventional square coil configurations of different sizes and an “L” shaped coil configuration are shown. The single layer “L” shaped coil has a similar diameter (i.e., 120 mm) to the smaller of the two square configurations and thus uses less wire. This causes the “L” shaped coil to have a lower impedance than the conventional square configuration. Further the impedance of the “L” shaped coil at 32 KHz is significantly lower than that of than that of the square-shaped coils shown in FIG. 6.

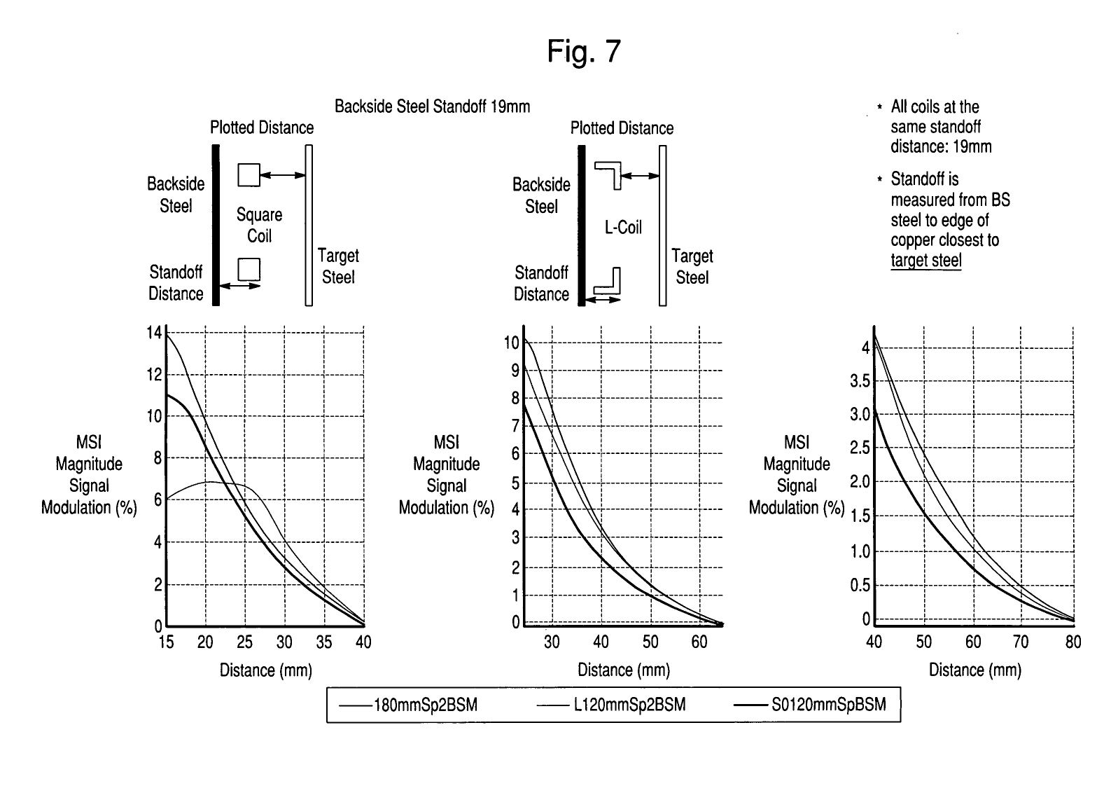

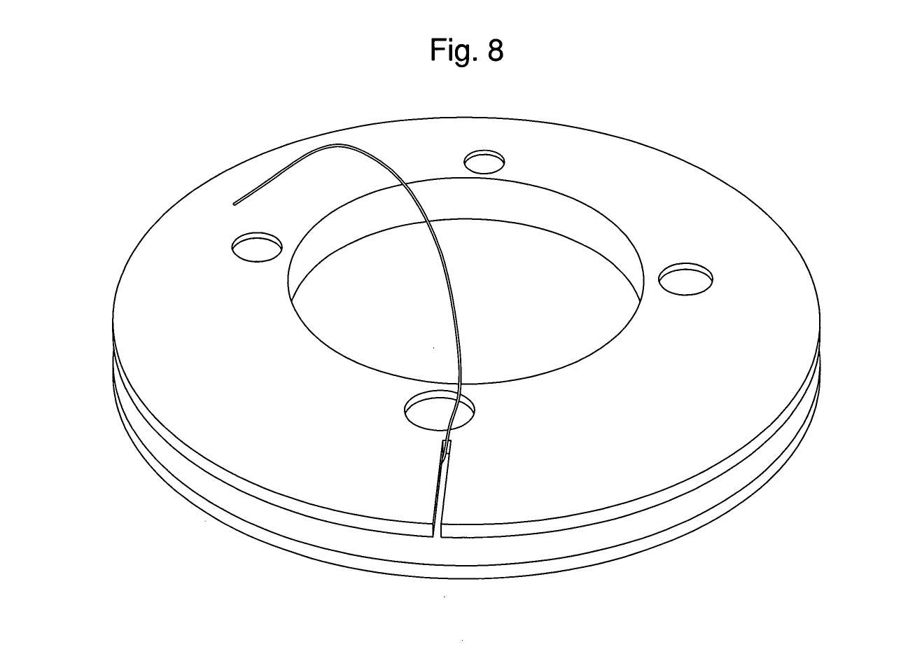

Referring to FIG. 7, a magnitude signal modulation (i.e., change in current through the coil 16) is illustrated for the coil 16 winding patterns of FIG. 6 in three graphs (A, B, and C). The coils 16 are attached to an exemplary steel backside (e.g., mounted 19 mm off) and configured to sense impedance or inductance of a target steel (electrically conductive) surface 14. As the plotted starting distance of the coil 16 from the electrically conductive surface 14 increases (e.g., about 40 mm in graph A, about 65 mm in graph B, and about 80 mm in graph C) the smaller “L” shaped coil results in signal performance (i.e., signal strength) similar to or better than that of a larger conventionally shaped coil when the distance between the coil 16 and the electrically conductive 14 is decreased.

Referring to FIG. 8, an exemplary coil 16 with an “L” shaped winding is illustrated.

Although the sensor system 10 is illustrated as including multiple features utilized in conjunction with one another, the sensor system 10 may alternatively utilize more or less than all of the noted mechanisms or features. For example, in other exemplary embodiments, the controller 18 may be a single unitary portion of the coil 16.

Although specific shapes of each element have been set forth in the drawings, each element may be of any other shape that facilitates the function to be performed by that element. For example, the coil windings have been shown to be of “L” shaped or flat patterns, however, in other embodiments the structure may define that of an arched, “U” shaped, or other form where the individual windings of the coil 16 are immediately next to fewer other windings than in the conventional square or rectangular design.

For purposes of this disclosure, the term “coupled” means the joining of two components (electrical, mechanical, or magnetic) directly or indirectly to one another. Such joining may be stationary in nature or movable in nature. Such joining may be achieved with the two components (electrical or mechanical) and any additional intermediate members being integrally defined as a single unitary body with one another or with the two components or the two components and any additional member being attached to one another. Such joining may be permanent in nature or alternatively may be removable or releasable in nature

The present disclosure has been described with reference to example embodiments, however persons skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

It is also important to note that the construction and arrangement of the elements of the system as shown in the preferred and other exemplary embodiments is illustrative only. Although only a certain number of embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the assemblies may be reversed or otherwise varied, the length or width of the structures and/or members or connectors or other elements of the system may be varied, the nature or number of adjustment or attachment positions provided between the elements may be varied. It should be noted that the elements and/or assemblies of the system may be constructed from any of a wide variety of materials that provide sufficient strength or durability. Accordingly, all such modifications are intended to be included within the scope of the present disclosure. Other substitutions, modifications, changes and omissions may be made in the design, operating conditions and arrangement of the preferred and other exemplary embodiments without departing from the spirit of the present subject matter.

What is claimed is:

1. A sensor system, comprising:
an electrically conductive surface;
an air coil, in proximity to the electrically conductive surface, having a wire winding pattern with an “L” shaped cross section;
a controller, coupled to the air coil, configured to sense a change in impedance of the air coil due to relative movement between the air coil and the electrically conductive surface; and
a safety device, coupled to the controller.

2. A sensor system according to claim 1, wherein the electrically conductive surface is a vehicle door panel comprised of metal.

3. A sensor system according to claim 1, wherein the electrically conductive surface is a metal plate attached to a vehicle door panel.

4. A sensor system according to claim 1, wherein the electrically conductive surface is a beam.

5. A sensor system according to claim 1, wherein the metal surface is a target metal plate attached to a beam.

6. A sensor system according to claim 1, wherein the safety device is a side-impact airbag.

7. A sensor system according to claim 1, wherein the safety device is a front or rear-impact airbag.

8. A sensor system according to claim 1, wherein the safety device is a seatbelt.

9. A sensor system according to claim 1, wherein the controller is configured to activate the safety device if the change in impedance of the air coil exceeds a predetermined threshold.

10. A sensor system, comprising:
an electrically conductive surface;
an air coil, in proximity to the electrically conductive surface, having a wire winding pattern with an “U” shaped cross section;
a controller, coupled to the air coil, configured to sense a change in impedance of the air coil due to relative movement between the coil and the electrically conductive surface; and
a safety device, coupled to the controller.

11. A sensor system according to claim 10, wherein the electrically conductive surface is a vehicle door panel.

12. A sensor system according to claim 10, wherein the electrically conductive surface is a metal plate attached to a vehicle door panel.

13. A sensor system according to claim 10, wherein the electrically conductive surface is a beam.

14. A sensor system according to claim 10, wherein the electrically conductive surface is a target metal plate attached to a beam.

15. A sensor system according to claim 10, wherein the safety device is a side-impact airbag.

16. A sensor system according to claim 10, wherein the safety device is a front or rear-impact airbag.

17. A sensor system according to claim 10, wherein the safety device is a seatbelt.

18. A sensor system according to claim 10, wherein the controller is configured to activate the safety device if the change in impedance of the air coil exceeds a predetermined threshold.

19. A sensor system, comprising:
an electrically conductive surface;
an air coil, in proximity to the electrically conductive surface, having a wire winding pattern with an arch shaped cross section;
a controller, coupled to the air coil, configured to sense a change in impedance of the air coil due to movement of the electrically conductive surface; and
a safety device, coupled to the controller.

20. An air coil, comprising:
a wire winding pattern, having an “L” shaped cross section.
